(19) United States
(12) Patent Application Publication
(10) Pub. No.: US 2010/0166257 A1
(43) Pub. Date: Jul. 1, 2010

(54) METHOD AND APPARATUS FOR DETECTING SEMI-TRANSPARENCIES IN VIDEO

(75) Inventor: Gordon F. Wredenhagen, Toronto (CA)

Correspondence Address: VOLPE AND KOENIG, P.C., UNITED PLAZA, SUITE 1600, 30 SOUTH 17TH STREET, PHILADELPHIA, PA, 19103, US

(73) Assignee: ATI Technologies ULC, Markham (CA)

(21) Appl. No.: 12/345,863

(22) Filed: Dec. 30, 2008

(51) Int. Cl. G06K 9/00; G06K 9/64

(52) U.S. Cl. 382/103; 382/278

(57) ABSTRACT

A method and apparatus for detecting semi-transparencies in video is disclosed.

### FIELD OF INVENTION

This application is related to image processing.

### BACKGROUND

Semi-transparent overlays are often inserted into video content for a number of reasons such as to express content ownership or channel identification—usually by means of a station logo or in the form of an On Screen Display. The detection of such semi-transparencies is often essential.

For example, such overlays may cause problems during motion estimation, a necessary step for high-quality frame rate conversion. The existence of semi-transparencies can present a formidable challenge to many video processing algorithms, not the least of which is frame rate conversion. The semi-transparency problem becomes even more apparent when video is motion compensated because the semi-transparent region is often dragged along with the motion of the most dominant local content. Additionally, it is often difficult for a motion estimation algorithm to determine the location of the semi-transparency because on any given frame, the combination of semi-transparent content blended with the background could be essentially invisible (i.e., undetectable). As a consequence, the displaced semi-transparent content, often in the form of a station identification logo alpha blended with the background, is corrupted. This leads to a noticeable and egregious visual artifact in the processed image. Moreover, the viewer understands that the logo, however slight and subtle, should not move since any vertical or horizontal displacement of the logo is displeasing.

The detection of semi-transparent logos may be used to help in detecting the presence of a commercial. Another application for the identification of semi-transparent logos, or logos in general, is the ability to find content that has been recorded and rebroadcast. For instance, video content providers on the internet, such as YouTube, allow users to post content in a free and open manner. It is very difficult to identify the content provider without requiring the party posting the new content to complete a submission form detailing the origins of the content (e.g., MSNBC, CBC, and so on). Moreover, it cannot always be assumed that such forms are accurate and valid. Should the video content provider be required to conduct an audit of the current content on its servers, it would be very difficult, if not impossible. However, if there was a mechanism in place that allowed for content to be identified via a logo (whether predefined or otherwise, semi-transparent or not), undertaking audits of content in a more automated and controlled fashion becomes manageable.

Previous solutions to the problem of semi-transparency detection have been focused on using edge persistence over a specified time period to detect semi-transparent content. The first step in identifying a semi-transparency using this method is to convolve the image with a high-pass filter. This process reveals edges on one frame of data at a specific time. The edges are accumulated through time and only edges that have persistence will remain dominant. A fundamental problem with the edge persistence approach is that it does not disclose anything about the interior of the semi-transparent region, only the edges of the semi-transparent region are identified.

The edge persistence approach also relies on the existence of a discernable edge about the perimeter of the semi-transparency. This is not always the case. Some logos, for example, are tapered towards their perimeter. In this, case it becomes problematic for an edge based detection scheme to work because there is no easily identifiable boundary to the pixels that contain the logo. Further, it cannot be assumed that the semi-transparency region is defined by a clear and well-defined edge. In fact, the edge is usually far from pristine; additional processing is usually required to clean it up. Some researchers have applied a morphological gradient to regularize and strengthen a logo boundary to help join together pieces of the logo boundary that are otherwise disconnected. Once some semblance of a continuous logo boundary is computed, the interior of the semi-transparent region must be filled in some way to identify all pixels in the resulting semi-transparent region. The process of “filling” the logo is far from obvious. If the interior of the logo contains many persistent edges, it can become very confusing as to what pixels comprise the interior of the logo. Compounding the problem, logo shapes vary; several logos have complex shapes and are tapered in different ways from left to right and top to bottom. The interior and exterior of a logo cannot be inferred by simply traversing the logo region because a simple even boundary can never be assumed.

If a semi-transparent video overlay is itself hollow (such as in the case of the letter “C”), then an edge persistence approach will erroneously include extraneous pixels as part of the semi-transparency. A morphological contour following algorithm may, depending on its internal settings, join the two tips of the letter C to form the letter “O.” Subsequent processing might incorrectly infer that the interior content of the letter O belongs to the logo. Although edge persistence approaches are often workable in that they are computable, it would be desirable to accurately identify only those pixels that truly belong to the semi-transparency and those that do not.

Accordingly, methods to detect the presence and location of semi-transparent or solid logos are desired. Such methods should also allow for some form of motion specific processing in a localized region. Additionally, the method must be fast and have a computational footprint that is as small as possible, minimizing the size of an ASIC implementing the method.

### SUMMARY

A method and apparatus for detecting semi-transparencies in video is disclosed.

### BRIEF DESCRIPTION OF THE DRAWINGS

A more detailed understanding may be had from the following description, given by way of example in conjunction with the accompanying drawings wherein:

FIG. 1 is an example of a semi-transparency in an image;

FIG. 2 is a minimum-maximum mask corresponding to FIG. 1 assuming that the background content is in motion;

FIG. 3 is an example of an edge persistence mask;

FIG. 4 is an edge persistence mask corresponding to the edge persistence map of FIG. 3;

FIG. 5 is a flow chart of an example variance mask method;

FIG. 6 is an example of a variance map corresponding to FIG. 1;

FIG. 7 is a variance mask corresponding to the variance map of FIG. 6;

FIG. 8 is an example of a user-defined mask;

FIG. 9 is an example of a combined mask; and

FIG. 10 is an example apparatus implementing the invention.

### DETAILED DESCRIPTION

When referred to hereafter, the term “logo” includes but is not limited to a semi-transparency. Often for clarity, the term logo is used to refer to a region where the semi-transparency is located on a screen, or within screen content.

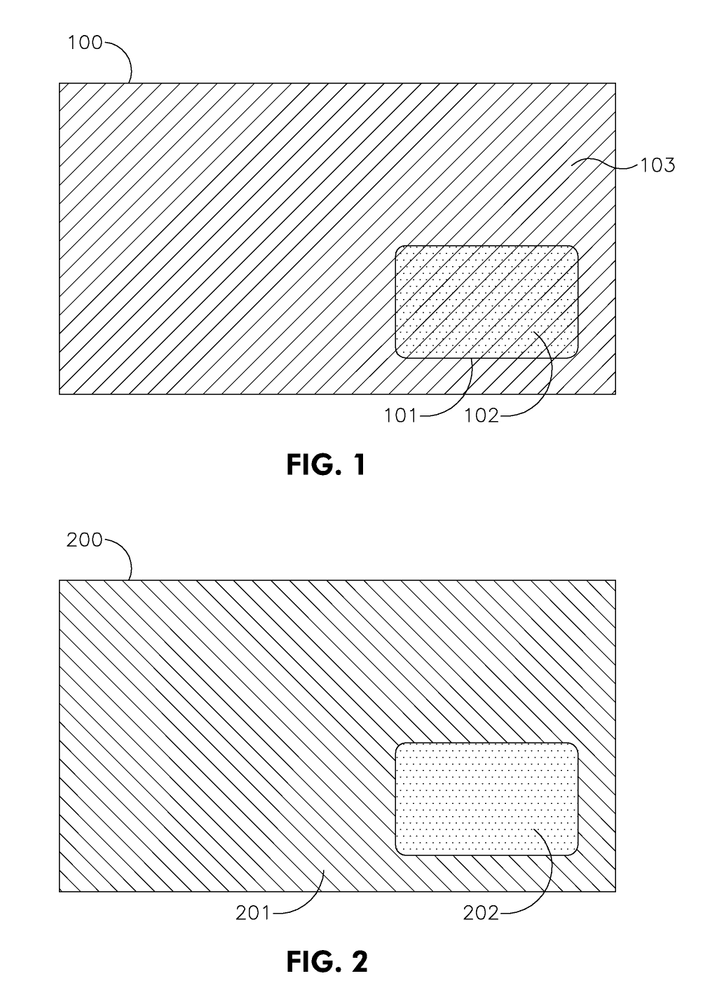

FIG. 1 is an example of a semi-transparency in an image. The image background is a screen 100 filled with an image 103 comprising slanted lines throughout the screen 100. A semi-transparent region 101 is blended with the image 103 so that the contrast of the image 103 is diminished therein, as shown by its interior 102.

In order to detect semi-transparencies, signal sampling is performed and the variability of the signals is measured. Signal variability can be measured in many ways. One standard way is to compute the mean and the variance of the signal samples. The mean is calculated from:

$$\overline{I} ( T , x , y ) = \frac{1}{n} {\sum }_{t = 1}^{T} I ( t , x , y ) \qquad Equation ( 1 )$$

Calculation of the mean of T samples

The variance is calculated from:

$${σ}^{2} ( T , x , y ) = \frac{1}{T ( T - 1 )} {\sum }_{i = 1}^{n} {( I ( t , x , y ) - \overline{I} ( T , x , y ) )}^{2} \qquad Equation ( 2 )$$

Variance equation for T samples

In the equation above, Ī(T,x,y), I(t,x,y), and (I(t,x,y)−Ī_{T}(T,x,y))² represent the mean of the first T samples (T being any positive integer), the current sample at time t (t being any integer), and the square of their difference, respectively. The symbol σ²(T,x,y) represents the variance of T samples at location (x, y). The coordinates x and y represent the horizontal and vertical position of a pixel in the image. The symbol Σ signifies the summation. The T samples refer to the sampling of values received via the red (R), green (G), blue (B), chrominance, luminance or other similar channels. Any single channel or any combination of channels may be sampled and utilized for the calculations herein.

A drawback of the standard approach for the mean and variance calculations is the requirement that the entire data set be recomputed each time a new sample is received. To make the process of computing the mean and the variance more efficient, a simple recursive computation can be used to update the mean and the variance. The recursive mean update equation is:

$$\overline{I} ( T , x , y ) = ( \frac{T - 1}{T} ) \overline{I} ( T - 1 , x , y ) + \frac{1}{T} I ( t , x , y ) \qquad Equation ( 3 )$$

The recursive variance update equation is:

$${σ}^{2} ( T , x , y ) = ( \frac{T - 2}{T} ) {σ}^{2} ( T - 1 , x , y ) + \frac{1}{T} {( \overline{I} ( T , x , y ) - \overline{I} ( T - 1 , x , y ) )}^{2} + \frac{1}{T ( T - 1 )} {( I ( T , x , y ) - \overline{I} ( T , x , y ) )}^{2} \qquad Equation ( 4 )$$

Wherein σ²(T,x,y) is the sample variance for the first T samples and σ²(T−1, x, y) is the sample variance for the first T−1 samples (T being any integer>=2). The variance is then used to generate a variance pixel map which in turn is used to generate (build) a variance pixel mask that indicates the region of the image comprising the semi-transparency.

In one embodiment, many detectors are combined to achieve a semi-transparency detection rate that is superior to any single detection mechanism. Learning techniques, such as Adaboost and Support Vector Machines (SVM) may increase classification rates. For instance, the Adaboost technique may be trained on source data to find the optimal thresholds that are used in one incantation of the mask generation phase, to be described in more detail below. Other salient parameters may be used in the optimization process to provide further optimization as described in the mask generation phase below. In general, parameters are adjusted in a controlled fashion, e.g., according to some learning algorithm (Adaboost, SVM, etc.), in such a way, that the classification performance is optimized.

A mask is a group of pixels identified by their location that indicates which pixels are part of the semi-transparent region and those that are not. There are many ways in which to obtain a mask.

One of the most effective ways of determining if a pixel belongs to a given semi-transparency, known as a minimum maximum mask, is to track the maximum and minimum values (0-255 for 8-bit data) a pixel can attain (such sampled values may include any or all of the following: R, G, B, luminance, chrominance, etc.). This can be done on each channel individually or in a combined fashion. The purpose of tracking a pixel's effective dynamic range is as follows: if the range seen at a pixel location is full-scale, then it cannot be part of a semi-transparent logo (it is assumed that the semi-transparent logo is time invariant, i.e., it does not disappear and reappear during the estimation process. Otherwise this would require the estimation process to start all over again). The semi-transparent overlay can be described mathematically as a blend between the content and a logo. The blend factor may be expressed in the form of a coefficient. The blend factor may also be expressed as a percentage with minor adjustments to the equations. For example, if C is the video content, and L is the logo, then the semi-transparency (ST):

ST=p*C+(1−p)*L Equation (5) Semi-transparency

where p is a blend coefficient between 0 and 1.

When p is 1, the resulting image ST contains only the video content C. At the other extreme, when p is 0, ST is the logo, which in this instance will appear solid. However, for any p between 0 and 1, the logo will appear as a semi-transparency. Certainly, for the logo portion of the semi-transparency to be visible, and therefore meaningful, p typically lies in the range of 0.2 to 0.8. This relationship can be exploited in terms of mask generation because the blended logo L actually reduces the possible dynamic range that the output content ST may attain. For example, with 8-bit video data, the dynamic range for the content is [0, 255]. Although some representations may be centered about 0, this is not important in the current context. Referring to Equation (5), if L=100 and p=0.7, then ST=0.7*C+30. Therefore, as content C is in the range [0, 255], the maximum and minimum range for ST is [30, 208.5]. Clearly, the maximum dynamic range has been diminished from [0, 255] to, in effect, [0, 178.5]. This result does not eliminate any pixels from consideration as being part of a semitransparent region being analyzed. However, if the maximum dynamic range is attained on any given pixel (the dynamic range of the pixel is equal to the maximum dynamic range, 178.5 in this example), then it cannot be part of the semi-transparency. To further qualify full dynamic range, p_min is ascribed as the minimum possible blend coefficient that is visually meaningful, then for blending coefficients less than, (e.g., 0.2), the semi-transparency would not be visible. If content on a given pixel swings further than 0.8 of its full unblended dynamic range, then that pixel cannot be part of a semi-transparency and can be eliminated from consideration.

Generating the minimum-maximum mask is as follows:

Given a pixel at location (x,y) at time t, the minimum(p(x,y)) and maximum(p(x,y)) are taken over all the samples.

(Typically for National Television Standards Committee (NTSC) resolution images, the useful range for x is from 0 to 719 and the useful range for y is from 0 to 479. Other resolution formats have different image sizes, and the overall range of the values that x and y can assume will vary.)

Let PMAX and PMIN denote the maximum and minimum measured values for pixel location (x,y) for the time of observance.

The maximum observed dynamic range is [PMIN, PMAX].

R is the likelihood that pixel at (x,y) is part of the semi-transparent region and is defined by:

R=1−[[(PMAX−PMIN)/F] Equation (6)

wherein:
F is the full-dynamic range
T is a threshold with a value greater than 0. The value of T may be predefined by a user, operator or system, etc.
   If R<T, then there is no possibility that the pixel at location (x,y) is part of the semi-transparent region.

FIG. 2 shows the results of applying the minimum-maximum mask 200 when the underlying content was moving. If it is assumed that the pixels that compose the letter “A” are full-scale, (e.g., 255 on 8-bit content), and the pixels that do not form part of the letter “A” are 0, then any pixels that transition from being part of the letter “A” to not being part of the letter “A” will be eliminated as being part of the semi-transparent region. Under sufficiently rich motion, all pixels that are not part of the semi-transparent region 202 in this scenario will be eliminated as being part of the semi-transparency as indicated by the lined region 201. Referring to Equation (6): R=1−[[255−0]/255]=0, thus for any T (T greater than 0), R<T and thus such a pixel not part of the semi-transparency.

The persistent edge mask shows time-persistent edges in the region under investigation. This is done by spatially differentiating the content using a filter such as a simple high-pass filter convolved with the content. Using this method in combination with the other proposed methods increases the effectiveness of detection mechanism. In one embodiment, if the content is moving, a semi-transparent region is identified using the variance approach. Time dependent statistics are gathered on the movement of the content in the semi-transparent region facilitating the identification/extraction process. If there has been no movement, edge persistence is applied to detect the ST region. It should be noted that normally there is noise in the image, but the noise will not usually help isolate the semi-transparent region because the noise statistics will be the same for both regions.

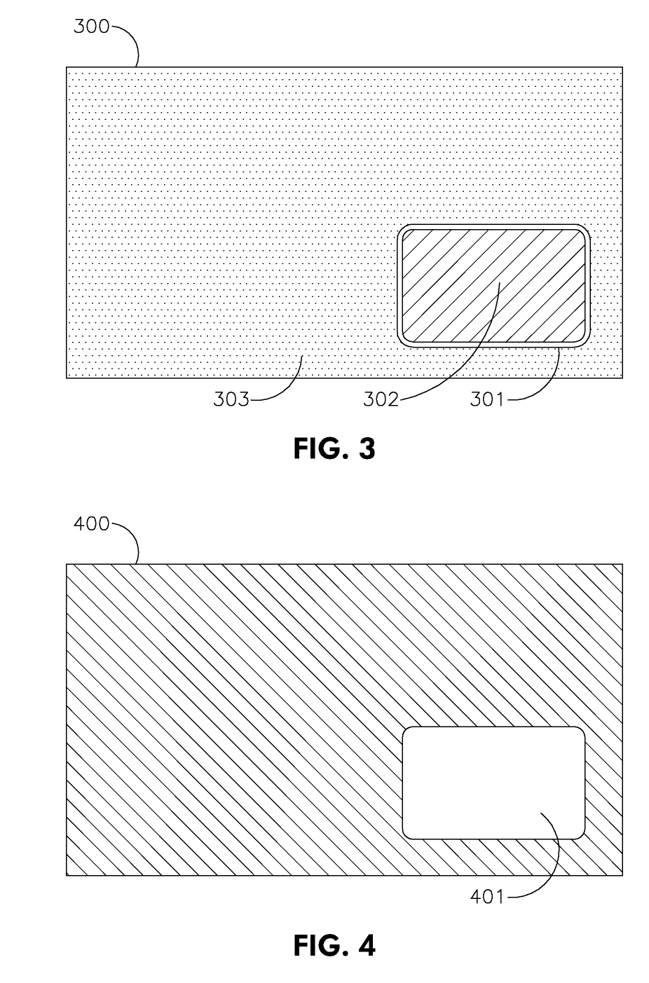

FIG. 3 shows the one possible edge persistence mask (300) corresponding to FIG. 1. The white region 301 represents the persistent edge whereas the lined region 302 represents the least persistent edges (the interior of the semi-transparent region) and the dotted region 303 shows the edge persistence otherwise. In this case, the dotted and white regions form part of the mask, and it is recognized that the edge persistence inside and outside of the semi-transparent region will be different by a small amount. Edges in the semi-transparent regions are likely to be subdued relative to the same content that is outside of the semi-transparent region. In this way, similar to how the mask was formed from the variance map, a threshold separates the two regions either determined from empirical study, or by means of a relative percentage that may be defined. From this a mask may be computed as shown in FIG. 4. FIG. 4 shows an ideal edge persistence mask (400) corresponding to the edge persistence map of FIG. 3. The region containing the semi-transparency (401) is clearly defined.

A persistent edge mask may be generated as follows:

convolve the image with a high-pass filter;

accumulate the result over all pixels and over all time until the current time;

a user-defined threshold or a pre-defined threshold (such as a system configured threshold) can be used to separate pixels that form part of the mask and those that do not; then:

all pixels that exceed threshold T are kept for further consideration(the pixels may be part of the semi-transparency); and

all others are discarded (the pixels are not part of the semi-transparency).

The threshold comparison may be done after a predefined number of images have been examined.

Alternatively, the threshold may also be interpreted as a percentage. That is, if the threshold is relative, then a normalization step is useful in determining how to include and exclude pixels from the mask. In this case, the maximum and minimum values are found in the edge persistence operation and the percentage threshold determines where the point of demarcation is set to eliminate pixels as belonging to persistent edges. So for example, if T=0.5, Max=200, MIN=0, then all edge pixels below 100 are removed and set to zero.

The variance mask is another type of mask. An example variance mask is defined by the variance calculations in Equation (3) and Equation (4) above. When taken as an ensemble, the variance can be viewed as an image in its own right that shows the variability of each pixel through time. The next step in the generation of a variance mask is to isolate regions in the variance mask that correspond to regions of lower variance and regions of higher variance. Higher variance regions are rejected and lower variance regions are retained for further consideration (further analysis). Typically a threshold is defined to separate these two regions. The threshold can be an absolute user-defined threshold, a programmable/configurable threshold, or it can be determined after a normalization step has taken place. That is, the threshold that separates the two regions can be defined relative to the measured maximum and minimum variance. Then the threshold can be interpreted as being a percentage between these two extremes and anything below the relative threshold is retained for further consideration (analysis) and anything equal to or above the threshold is not considered for further evaluation.

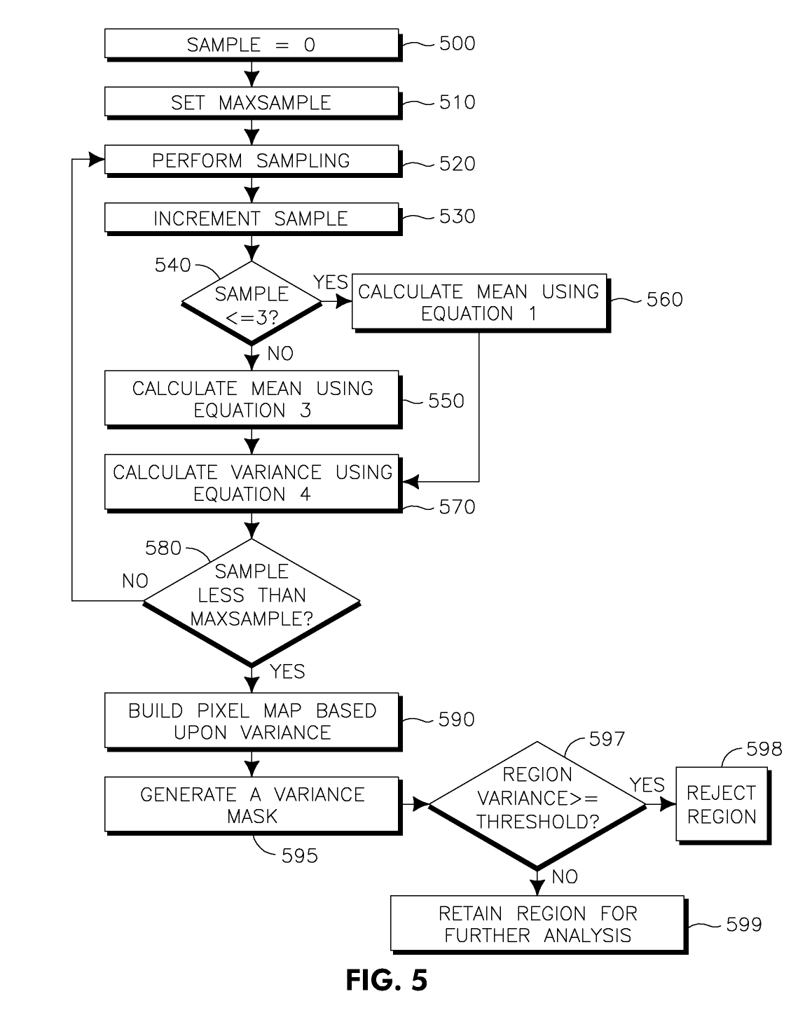

FIG. 5 is one example of an embodiment for generating a variance mask. A counter, sample is initialized to 0 (500). This variable counts the number of samples. A maximum sample variable is then initialized, maxsample (510). This variable is configured, for example, by the user, and represents the maximum amount of samples to be performed and analyzed. Sampling is performed (520) and the sample counter is incremented (530). Next, it is determined if the current value of the sample counter is less than or equal to three (540). This test is performed to insure that three samples are analyzed before applying the optimized recursive update mean calculation (at least two samples are necessary). If three or less samples have been performed, the mean is calculated using Equation (1) (560). If more than three samples have been performed, then the mean is calculated using Equation (3) (550), the optimized recursive mean calculation. The variance between the samples is calculated using Equation (4) (570). It is then determined if the maximum number of samples have been performed (580). If not, then sampling continues (520). If the maximum number of samples has been performed, this means that sampling has concluded, and a pixel map is built based upon the variance (590) and the variance mask is generated (595). The variance mask displays an image that organizes/shades image regions by their respective variance. The variance of a region is compared to a threshold (597). If the variance is equal to or greater than the threshold, the region is rejected (598). If the variance of the region is less than the threshold, then the region is retained for further analysis (599).

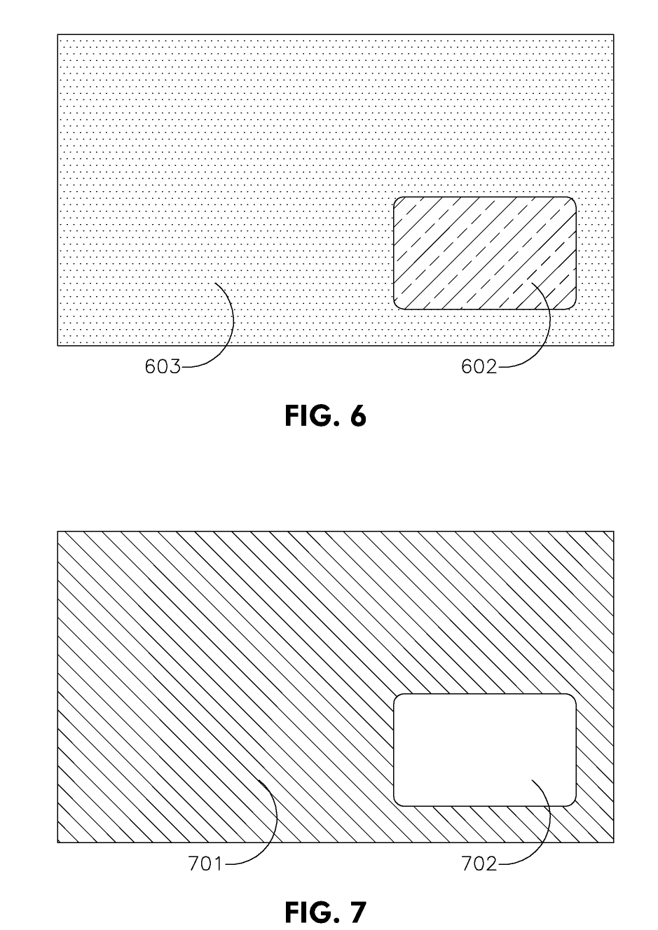

The variance map in FIG. 6 shows two distinct regions 603 and region 602. Region 603 is a dotted region, indicating that it has higher variance than the latter lined region 602. Typically, the semi-transparency is blended with the background with a constant blending factor. This means that for a digital panel (for example, 8-bit, or 10-bit), the variance of the blended content in the semi-transparent region can be determined across typical content. Assuming blending factors that are reasonable, such as 40-60%, from an empirical examination of such content, a threshold can be defined above which content is deemed too variable to be considered part of the semi-transparent region. As such, the variance mask derived from the variance map will assume that shown in FIG. 7.

Referring to FIG. 7, the lined region 701 indicates a region that does not contain the semi-transparency, and the white region 702 indicates a region containing the semi-transparency. It should be noted that a relative threshold could also be employed as a demarcation point between these regions.

Semi-transparency detection and subsequent mask generation as described above is blind. That is, there is no a priori knowledge that can be used to help improve detection success. However, broadcasters and content providers typically do not change their station identification markers very often. In another embodiment, a copy of one or more logos is stored in computer memory or other suitable location for the storage of information/data. The stored logo (or logos) is then used as a reference to determine whether a given logo is present or not in content being analyzed. In this embodiment, the stored logo information is correlated with what is being extracted from the real-time image. For example, the stored logo information is correlated with the edge maps, the maximum and minimum map, or the variance map, or any combination of these and other detection methods. A correlation, using any or all of these methods, above a certain first threshold means that a logo is present. A further correlation test is performed using the stored reference logo. The highest correlation amongst all correlated logos above a second threshold is the probable logo. The first and second thresholds may be configured by a user, or by any other suitable method for configuring a threshold; additionally, the thresholds may be periodically adjusted.

Depending on the content, the statistics may favor one form of mask over another. For example, if the content shows a herd of racing zebras on the Serengeti, the black and white stripes may easily cause the dynamic range on almost all pixels not associated with the semi-transparency to achieve their maximum dynamic range, thereby eliminating them from being part of the semi-transparency. In this case, the minimum-maximum mask will be particularly useful. If on the other hand, the content is of lower contrast, rendering the minimum-maximum mask of less utility, e.g., the content is blowing grass in a field without the zebras, the variance approach could be very useful and the mask will quite accurately reveal the presence of the semi-transparency. If there is no wind, and the content is effectively static, then neither the minimum-maximum mask, nor the variance mask will be helpful, but the edge persistence map may be helpful in determining the location of the logo. At any given time, the content may be varied in such a way as to favor one technique over another. The power of the approach is that the estimates become better with the introduction on new information and the effect is accumulative. By combining all three masks, the overall detection and extraction may become far more reliable than similar processing using only one technique.

Other masks may also be useful to the semi-transparent identification process. Location specific masks can be applied that direct the logo search to specific location(s)/region(s) in the image or to exclude certain image location(s)/region(s) from the search. For example, a location mask could utilize the fact that the semi-transparencies used for station identification are typically in the corners of the image and are rarely in the center.

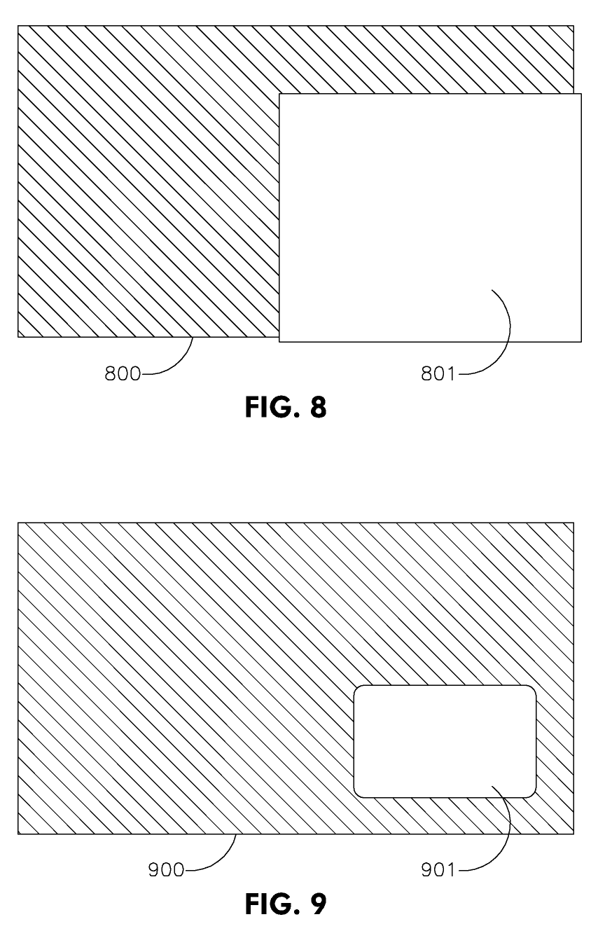

FIG. 8 is one example of such a user defined mask where lined region 800 is eliminated from analysis (no semi-transparency search will be performed in this region) and white region 801 will be analyzed to determine the set of pixels that comprise the semi-transparency.

In another example, a mask specific to the general region in which on-screen-displays (logo(s)) reside is applied to mask all but the targeted region. A mask may be created to only consider the center of an image, or a mask may be created to target semi-transparency detection in the bottom right region of the screen. In this way, an arbitrary number of masks, whether predefined or user-defined, can be applied in combination with other generated masks such as the variance mask or the minimum-maximum mask, to affect a more targeted search during identification.

As with many image processing steps, the generation of masks based on the inclusion or exclusion of pixel data is subject to error. During the generation of the above masks, it is possible for one or more isolated pixels, or a small group of isolated and otherwise disconnected pixels, to persist by the process of attrition (rejection or removal) in determining which pixels belong to the semi-transparency and which do not. These pixels are eliminated by a subsequent filtering step. In one embodiment, a median filter is employed. A median filter, for example, is known to be able to remove outliers, or they can be used to remove clusters of pixels in a way that is mask-specific. That is, on the variance mask, which identifies all pixels that are deemed to comprise part of the semi-transparency, the median filter that is used to remove outliers has a broader range than the one that is applied to the edge persistence mask. In the latter case, a 3×1 directional median filter is used, and in the former case a 3×3 median filter can be employed. In general, the filters are programmable and their specific behavior may vary as a consequence. One axis of variability is the fact that the filters are adjustable in height and width. As such, the optimal filter size can be determined as part of the training process.

There are various ways in which to combine marks. One way is to use a voting scheme. In one embodiment, a pixel is eliminated from consideration, (i.e., not considered part of the semi-transparency), if at least two masks, individually, indicate that the pixel is not part of the semi-transparency. In this way, many more potential masks can be included to help determine whether or not a pixel belongs to a semi-transparent region. The democratic voting scheme can include another parameter, namely, the degree of agreement. For example, if we have n (n being any positive integer) masks, then an agreement threshold could be set, which when achieved (or exceeded), indicates that a given pixel (or pixels) is part of the semi-transparent region, e.g., if the threshold is 7, then at least 7 masks would need to agree that the pixel is in the semi-transparent region.

FIG. 9 shows a combined mask derived from the previously determined masks in the ideal case. The application of the combined mask yields an estimate of the minimal region containing the semi-transparency, white region 901. Whereas lined region 900, the area not encompassed by region 901, does not contain the semi-transparent region.

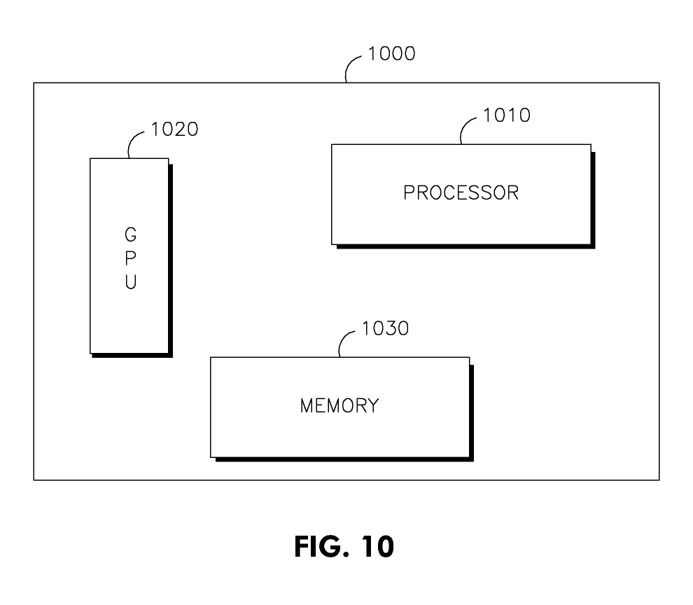

FIG. 10 shows an example of a semi-transparency detection apparatus 1000 configured to implement the invention. The apparatus 1000 contains a processor 1010 electrically connected to a memory 1030 and also electrically connected to an optional graphics processing unit (GPU) 1020. Sampling and processing of the appropriate methods may be performed by the processor 1010 on data residing in memory 1030. Alternatively, some processing may be performed by the GPU 1020 on data in memory 1030 and or on data sent to the GPU 1020 from processor 1010.

Although features and elements are described above in particular combinations, each feature or element can be used alone without the other features and elements or in various combinations with or without other features and elements. The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors may be manufactured by processing and using hardware description language instructions stored on a computer readable media. Once processed, maskworks may be created which configure a semiconductor manufacturing process to manufacture the semiconductor device.

What is claimed is:

1. A method for detecting semi-transparencies in a video image comprising:
determining a variance between a plurality of pixel samples;
applying a recursive computation to update a mean and the variance;
generating a variance map; and
generating a variance mask based upon the variance map.

2. The method of claim 1 further comprising:
rejecting image regions that are above a variance threshold; and
retaining for analysis image regions that are below the variance threshold.

3. The method of claim 2 wherein the threshold is one of user-defined or pre-defined.

4. A method for detecting semi-transparencies in a video image comprising:
applying a minimum maximum mask.

5. The method of claim 4 further comprising:
tracking a dynamic range of a pixel; and
eliminating the pixel from further consideration if a diminished maximum dynamic range is attained.

6. A method of semi-transparency detection in video comprising:
applying at least one of a minimum-maximum mask, a variance mask, a persistence edge mask, a predefined region mask or a user defined mask.

7. The method of claim 6 further comprising:
determining if a pixel is part of a transparency via a voting scheme.

8. The method of claim 6 further comprising normalization.

9. The method of claim 6 further comprising:
storing a first logo;
correlating the stored logo with the detected semi-transparency;
determining that a second logo is present if correlation exceeds a first threshold; and
determining that the detected semi-transparency is a probable first logo if the correlation exceeds a second threshold and is a highest correlation.

10. A semi-transparency detection apparatus comprising:
a processor configured to determine the variance between a plurality of pixel samples;
the processor further configured to apply a recursive computation to update a mean and the variance;
the processor further configured to generate a variance map; and
the processor further configured to generate a variance mask based upon the variance map.

11. The detection apparatus of claim 10 further comprising:
the processor configured to reject regions of the variance mask that correspond to variance above a threshold; and
the processor further configured to retain regions of the variance mask that correspond to variance below a threshold for further analysis.

12. The detection apparatus of claim 10 wherein the threshold is any one of user-defined or configured.

13. A semi-transparency detection apparatus comprising:
a processor configured to apply a minimum maximum mask.

14. The detection apparatus of claim 13 further comprising:
the processor configured to track a dynamic range of a pixel; and
the processor further configured to eliminate the pixel from further consideration if a diminished maximum dynamic range is attained.

15. A semi-transparency detection apparatus comprising:
a processor configured to apply at least one of a minimum-maximum mask, a variance mask, a persistence edge mask, a predefined region mask or a user defined mask.

16. The detection apparatus of claim 15 further comprising:
the processor further configured to determine if a pixel is part of a semi-transparency via a voting scheme.

17. The detection apparatus of claim 15 comprising:
the processor further configured to perform normalization.

18. The detection apparatus of claim 15 further comprising:
a memory configured to store a first logo;
a processor configured to correlate the stored logo with the detected semi-transparency;
the processor further configured to determine that a second logo is present if correlation exceeds a first threshold; and
a processor further configured to determine that the detected semi-transparency is a probable first logo if the correlation exceeds a second threshold and is a highest correlation.

19. A computer readable storage medium comprising:
a first set of instructions adapted to create a processor, wherein the processor is configured to implement a second set of instructions, the second set of instructions comprising:
a variance code segment for determining the variance between a plurality of pixel samples;
a recursive computation code segment for applying a recursive computation to update a mean and the variance;
a map generating code segment for generating a variance map; and
a mask generating code segment for generating a variance mask based upon the variance map.

20. The computer readable medium of claim 19 wherein the first set of instructions or the second set of instructions are hardware description language (HDL) instructions.
